(19) United States
(12) Patent Application Publication
(10) Pub. No.: US 2023/0072491 A1
(43) Pub. Date: Mar. 9, 2023

(54) NETWORK PROCESSING USING MULTI-LEVEL MATCH ACTION TABLES

(71) Applicant: Microsoft Technology Licensing, LLC, Redmond, WA (US)

(72) Inventors: Sumit Sharad Dhoble, Redmond, WA (US); Rishabh Tewari, Sammamish, WA (US); Avijit Gupta, Sammamish, WA (US); Madhan Sivakumar, Redmond, WA (US); Kedar Rajendra Gujar, Seattle, WA (US); Manasi Deval, Redmond, WA (US); Pranjal Shrivastava, Redmond, WA (US); Deven Jagasia, Kirkland, WA (US); Michal Czeslaw Zygmunt, Kirkland, WA (US)

(21) Appl. No.: 17/470,932

(22) Filed: Sep. 9, 2021

(51) Int. Cl. H04L 12/741; H04L 29/06; H04L 12/931; H04L 12/721

(52) U.S. Cl. CPC H04L 45/745; H04L 69/22; H04L 49/20; H04L 45/566

(57) ABSTRACT

Distributed computing systems, devices, and associated methods of packet processing are disclosed herein. One example method includes receiving a packet having a header with a protocol field, a source address field, a source port field, a destination address field, and a destination port field individually containing a corresponding value. The method also includes extracting the values of the protocol field, the source address field, the source port field, the destination field, and the destination port field, determining whether a first match action table (“MAT”) contains an entry indexed to the extracted values, and in response to determining that the first MAT does not contain an entry indexed to the extracted values, using a subset of the extracted values to identify an entry in a second MAT.

### BACKGROUND

Distributed computing systems typically include routers, switches, bridges, and other physical network devices that interconnect large numbers of servers, network storage devices, or other types of electronic devices. The individual servers can host one or more virtual machines (“VMs”), containers, virtual switches, or other virtualized functions. The virtual machines or containers can facilitate execution of suitable applications for individual users to provide desired computing services to the users via a computer network such as the Internet.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In cloud-based datacenters or other large-scale computing systems, overlay protocols, such as Virtual Extensible Local Area Network (“VELAN”) and virtual switching, can involve complex packet manipulation actions. For example, a virtual switch at a host can be configured to perform flow action matching for incoming/outgoing packets using a Match Action Table (“MAT”). In certain implementations, upon receiving packets at the host, the virtual switch can be configured to extract 5-tuples values (e.g., protocol, source address, source port, destination address, and destination port) from headers of the packets. The virtual switch can then apply a hash function to the extracted 5-tuples values to derive a hash value. Using the hash value as a key or index, the virtual switch can perform a lookup in the MAT to identify a network connection or “flow” the packets belong to and corresponding actions to be performed on the packets of the network connection or flow.

In certain computing systems, applying flow action matching to packets may cause communications interruption due to a finite size of the MAT limited by resource available at a host. During operation, a virtual switch consumes a certain amount of processing, memory, storage, or other types of resources at the host to manage a network connection or flow. Such resources at the host are finite. As such, the number of network connections or flows in the MAT has a ceiling limited by the available resources at the host. Thus, as the number of network connections or flows exceeds the ceiling of the MAT, further requests for establishing additional network connections or flows may be rejected, or one or more existing network connections or flows may be dropped. As a result, network traffic in the computing systems may be interrupted to prevent timely delivery of computing services to users and negatively impact user experience.

Several embodiments of the disclosed technology can address certain aspects of the foregoing difficulties by implementing multi-level MATs at a virtual switch or other suitable network nodes in distributed computing systems. Inventors have recognized that processing packets of certain network connections or flows may not require all 5-tuples. For example, an Express Route (“ER”) gateway can serve as a next hop for secured network traffic from an on-premises network (e.g., a private network of an organization) to a virtual network in a datacenter. When processing packets of the secured network traffic, the ER gateway can typically omit source address or source port during flow matching because packets with all values of source address or source port may be processed similarly. As such, the MAT can be configured to include an entry based on 4-tuples (e.g., protocol, source address, destination address, destination port) that corresponds to packets from multiple (e.g., 64,000) source addresses or source ports. Thus, the number of entries in the MAT using 4-tuples can be significantly reduced from that using 5-tuples.

According to aspects of the disclosed technology, a virtual switch, a network interface card (“NIC”), a co-processor of a NIC, or other suitable network nodes can have access to multi-level MATs based on different numbers and/or combinations of 5-tuples for flow matching. For example, the virtual switch can include a first MAT can include entries based on all 5-tuples while a second MAT includes entries based on 4-tuples (e.g., without source port values). During operation, the virtual switch can be configured to perform lookup in the multi-level MATs in a hierarchical manner. For example, the virtual switch can initially perform a lookup in the first MAT using a hash value of all 5-tuples. In response to locating an entry in the first MAT that matches the hash value of all 5-tuples, the virtual switch can identify the corresponding flow and an action to be performed on the packets of the flow. In response to a failure to locate an entry in the first MAT that matches the hash value of 5-tuples, the virtual switch can be configured to apply the hash function on values of 4-tuples to derive another hash value of 4-tuples. The virtual switch can then perform a lookup in the second MAT using the hash value of 4-tuples to locate an entry that corresponds to a flow and a corresponding action to be performed on the packets of the flow.

Several embodiments of the disclosed technology can thus significantly reduce sizes of MATs in virtual switches, NICs, or other network nodes in the distributed computing system. By using values of 4-tuples instead of values of 5-tuples, flows from multiple source port (or source address) can be aggregated into a single network connection or flow. Thus, a risk of exceeding a ceiling for the first or second MAT can be reduced to accommodate additional numbers of network connections or flows. As a result, dropped connections or connection refusals can be reduced to improve user experience of various computing services provided in the distributed computing system.

### BRIEF DESCRIPTION OF THE DRAWINGS

FIG. 1 is a schematic diagram illustrating a distributed computing system implementing network processing using multi-level Match Action Tables in accordance with embodiments of the disclosed technology.

FIG. 2 is a schematic diagram illustrating certain hardware/software components of the distributed computing system of FIG. 1 in accordance with embodiments of the disclosed technology.

FIGS. 3A and 3B are schematic diagrams illustrating example operations at a hardware packet processor at a host in a distributed computing system in accordance with embodiments of the disclosed technology.

FIGS. 4A and 4B are schematic diagrams illustrating Match Action Tables indexed to different packet parameters in accordance with embodiments of the disclosed technology.

FIGS. 5A and 5B illustrate an example data schema suitable for a packet header in accordance with embodiments of the disclosed technology.

FIG. 6 is a flowchart illustrating a process for network processing using multi-level Match Action Tables in accordance with embodiments of the disclosed technology.

FIG. 7 is a computing device suitable for certain components of the distributed computing system in FIG. 1.

### DETAILED DESCRIPTION

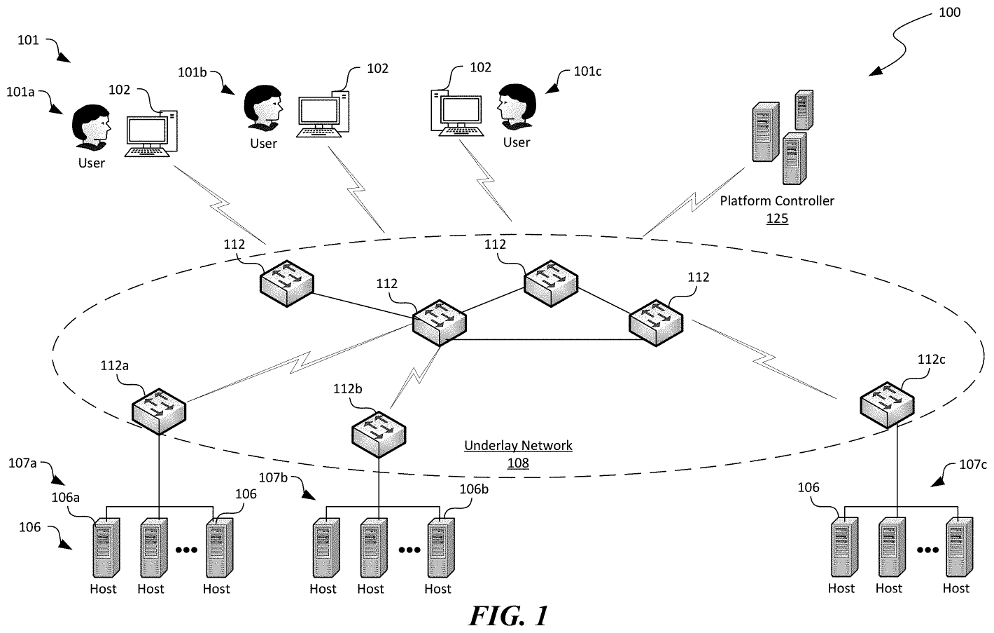

Certain embodiments of systems, devices, components, modules, routines, data structures, and processes for network processing using multi-level Match Action Tables in datacenters or other suitable distributed computing systems are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-7.

As used herein, the term “distributed computing system” generally refers to an interconnected computer system having multiple network nodes that interconnect a plurality of servers or hosts to one another and/or to external networks (e.g., the Internet). The term “network node” generally refers to a physical or virtualized network device. Example network nodes include physical or virtual network devices such as Network Interface Cards (“NICs”), routers, switches, hubs, bridges, load balancers, security gateways, or firewalls. A “host” generally refers to a physical or virtual computing device configured to implement, for instance, one or more virtual machines, containers, virtual switches, or other suitable virtualized components. For example, a host can include a server having a hypervisor configured to support one or more virtual machines hosting one or more containers, virtual switches, or other suitable types of virtual components.

A computer network can be conceptually divided into an overlay network implemented over an underlay network. An “overlay network” generally refers to an abstracted network implemented over and operating on top of an underlay network. The underlay network can include multiple physical network nodes interconnected with one another. An overlay network can include one or more virtual networks. A “virtual network” generally refers to an abstraction of a portion of the underlay network in the overlay network. A virtual network can include one or more virtual end points referred to as “tenant sites” individually used by a user or “tenant” to access the virtual network and associated computing, storage, or other suitable resources. A tenant site can host one or more tenant end points (“TEPs”), for example, virtual machines. The virtual networks can interconnect multiple TEPs on different hosts. Virtual network nodes in the overlay network can be connected to one another by virtual links individually corresponding to one or more network routes along one or more physical network nodes in the underlay network.

Further used herein, a Match Action Table (“MAT”) generally refers to a data structure having multiple entries in a table format. Each of the entries can include one or more conditions and one or more corresponding actions. The one or more conditions can be configured by a network controller (e.g., a Software Defined Network or “SDN” controller) for matching a set of header fields of a packet. The action can also be programmed by the network controller to apply an operation to a packet when the conditions match the set of values in header fields of the packet. The applied operation can modify at least a portion of the packet to forward the packet to an intended destination. Further used herein, a “flow” generally refers to a stream of packets received/transmitted via a single network connection between two end points (e.g., servers, virtual machines, or applications executed in the virtual machines). A flow can be identified by, for example, an IP address and a TCP port number. A flow can have one or more corresponding entries in the MAT having one or more conditions and actions.

Example conditions can include source/destination MAC, source/destination IP, source/destination TCP port, source/destination User Datagram Protocol (“UDP”) port, general routing encapsulation key, Virtual Extensible LAN identifier, virtual LAN ID, or other metadata regarding the payload of the packet. Conditions can have a type (such as source IP address) and a list of matching values (each value may be a singleton, range, or prefix). For a condition to match a packet, any of the matching values can match as in an OR clause. For a rule to match, all conditions in the rule match as in an AND clause.

The action can contain a type and a data structure specific to that type with data needed to perform the action. For example, an encapsulation rule can take as input data a source/destination IP address, source/destination MAC address, encapsulation format and key to use in encapsulating the packet. The example actions can include allow/reject a packet according to, for example, access control lists, network name translation (L3/L4), encapsulation/decapsulation, quality of service operations (e.g., rate limiting, marking differentiated services code point, metering, etc.), encryption/decryption, stateful tunneling, and routing (e.g., equal cost multiple path routing).

The rule can be implemented via a callback interface, e.g., to initialize, process packet, and de-initialize. If a rule type supports stateful instantiation, a network node, such as a virtual switch or other suitable types of process handler can create a pair of flows. Flows can also be typed and have a similar callback interface to rules. A stateful rule can include a time to live for a flow, which is a period that a created flows can remain in a flow table after a last packet matches unless expired explicitly by a TCP state machine. In addition to the foregoing example set of actions, user-defined actions can also be added, allowing the network controllers to create own rule types using a language for header field manipulations.

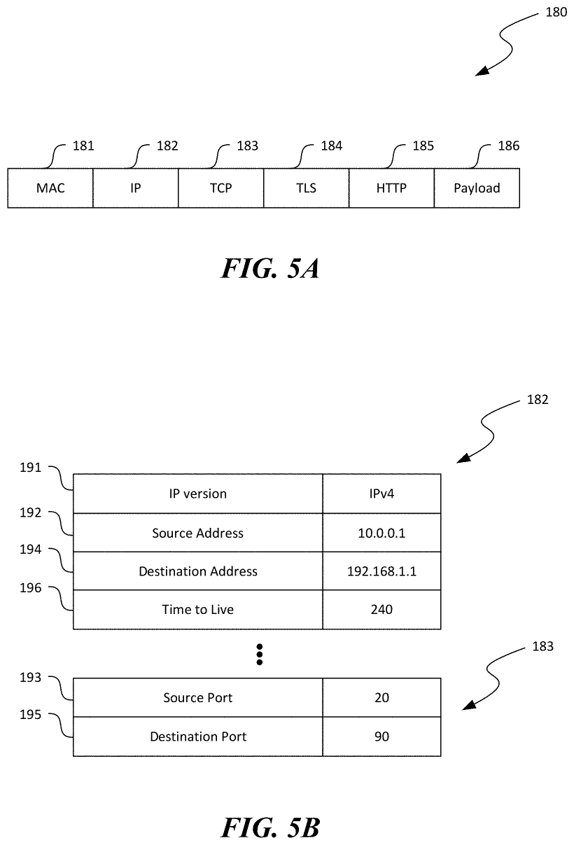

As used herein, a “packet” generally refers to a formatted unit of data carried by a packet-switched network. A packet typically can include user data along with control data. The control data can provide information for delivering the user data. For example, the control data can include source and destination network addresses/ports, error checking codes, sequencing information, hop counts, priority information, security information, or other suitable information regarding the user data. Typically, the control data can be contained in headers and/or trailers of a packet. The headers and trailers can include one or more data fields containing suitable information. As used herein, “5-tuples” generally refers to a set of values of control data corresponding to protocol, source address, source port, destination address, and destination port in a header or trailer of a packet. Also, “4-tuples” generally refers to a subset of 5-tuples, for instance, without the control data in source address or source port. An example data schema for control data is described in more detail below with reference to FIGS. 5A-5B.

FIG. 1 is a schematic diagram illustrating a distributed computing system 100 implementing network processing using multi-level MATs in accordance with embodiments of the disclosed technology. As shown in FIG. 1, the distributed computing system 100 can include an underlay network 108 interconnecting a plurality of hosts 106, a plurality of client devices 102 associated with corresponding users 101, and a platform controller 125 operatively coupled to one another. Even though particular components of the distributed computing system 100 are shown in FIG. 1, in other embodiments, the distributed computing system 100 can also include additional and/or different components or arrangements. For example, in certain embodiments, the distributed computing system 100 can also include network storage devices, additional hosts, and/or other suitable components (not shown) in other suitable configurations.

As shown in FIG. 1, the underlay network 108 can include one or more network nodes 112 that interconnect the multiple hosts 106 and the client devices 102 of the users 101. In certain embodiments, the hosts 106 can be organized into racks, action zones, groups, sets, or other suitable divisions. For example, in the illustrated embodiment, the hosts 106 are grouped into three host clusters identified individually as first, second, and third host clusters 107a-107c. Each of the host clusters 107a-107c is operatively coupled to a corresponding network nodes 112a-112c, respectively, which are commonly referred to as “top-of-rack” network nodes or “TORs.” The TORs 112a-112c can then be operatively coupled to additional network nodes 112 to form a computer network in a hierarchical, flat, mesh, or other suitable types of topologies. The underlay network 108 can be configured to allow communications among hosts 106, the platform controller 125, and the users 101. In other embodiments, the multiple host sets 107a-107c may share a single network node 112 or can have other suitable arrangements.

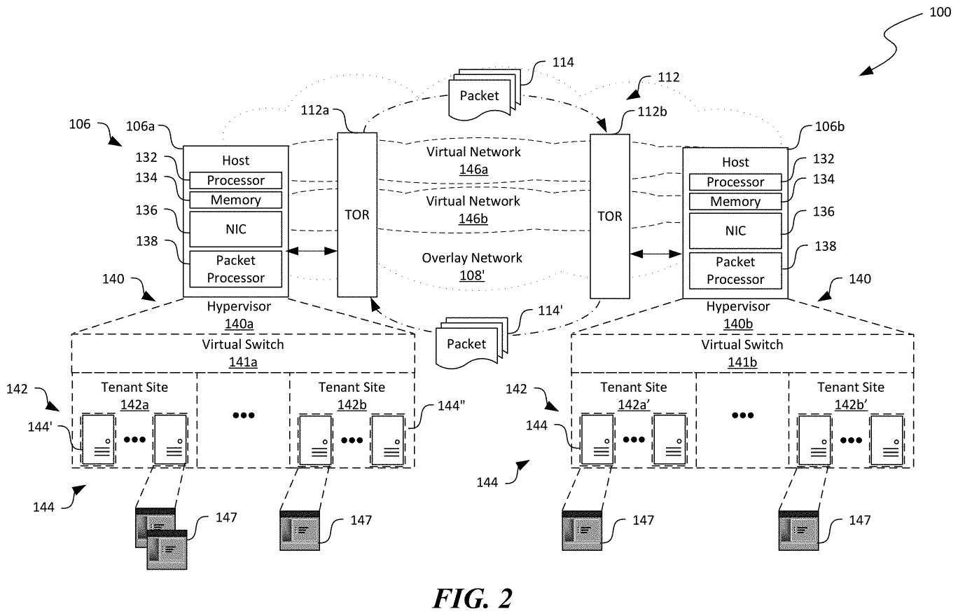

The hosts 106 can individually be configured to provide computing, storage, and/or other suitable cloud or other suitable types of computing services to the users 101. For example, as described in more detail below with reference to FIG. 2, one of the hosts 106 can initiate and maintain one or more virtual machines 144 (shown in FIG. 2) upon requests from the users 101. The users 101 can then utilize the provided virtual machines 144 to perform computation, communications, and/or other suitable tasks. In certain embodiments, one of the hosts 106 can provide virtual machines 144 for multiple users 101. For example, the host 106a can host three virtual machines 144 individually corresponding to each of the users 101a-101c. In other embodiments, multiple hosts 106 can host virtual machines 144 for the users 101a-101c.

The client devices 102 can each include a computing device that facilitates the users 101 to access cloud services provided by the hosts 106 via the underlay network 108. In the illustrated embodiment, the client devices 102 individually include a desktop computer. In other embodiments, the client devices 102 can also include laptop computers, tablet computers, smartphones, or other suitable computing devices. Though three users 101 are shown in FIG. 1 for illustration purposes, in other embodiments, the distributed computing system 100 can facilitate any suitable numbers of users 101 to access cloud or other suitable types of computing services provided by the hosts 106 in the distributed computing system 100.

The platform controller 125 can be configured to manage operations of various components of the distributed computing system 100. For example, the platform controller 125 can be configured to allocate virtual machines 144 (or other suitable resources) in the distributed computing system 100, monitor operations of the allocated virtual machines 144, or terminate any allocated virtual machines 144 once operations are complete. In the illustrated implementation, the platform controller 125 is shown as an independent hardware/software component of the distributed computing system 100. In other embodiments, the platform controller 125 can also be a datacenter controller, a fabric controller, or other suitable types of controllers or a component thereof implemented as a computing service on one or more of the hosts 106.

FIG. 2 is a schematic diagram illustrating certain hardware/software components of the distributed computing system 100 in accordance with embodiments of the disclosed technology. FIG. 2 illustrates an overlay network 108′ that can be implemented on the underlay network 108 in FIG. 1. Though particular configuration of the overlay network 108′ is shown in FIG. 2, in other embodiments, the overlay network 108′ can also be configured in other suitable ways. In FIG. 2, only certain components of the underlay network 108 of FIG. 1 are shown for clarity.

In FIG. 2 and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2, in the illustrated embodiment, the first host 106a and the second host 106b can each include a processor 132, a memory 134, and a network interface card 136, and a packet processor 138 operatively coupled to one another. In other embodiments, the hosts 106 can also include input/output devices configured to accept input from and provide output to an operator and/or an automated software controller (not shown), or other suitable types of hardware components.

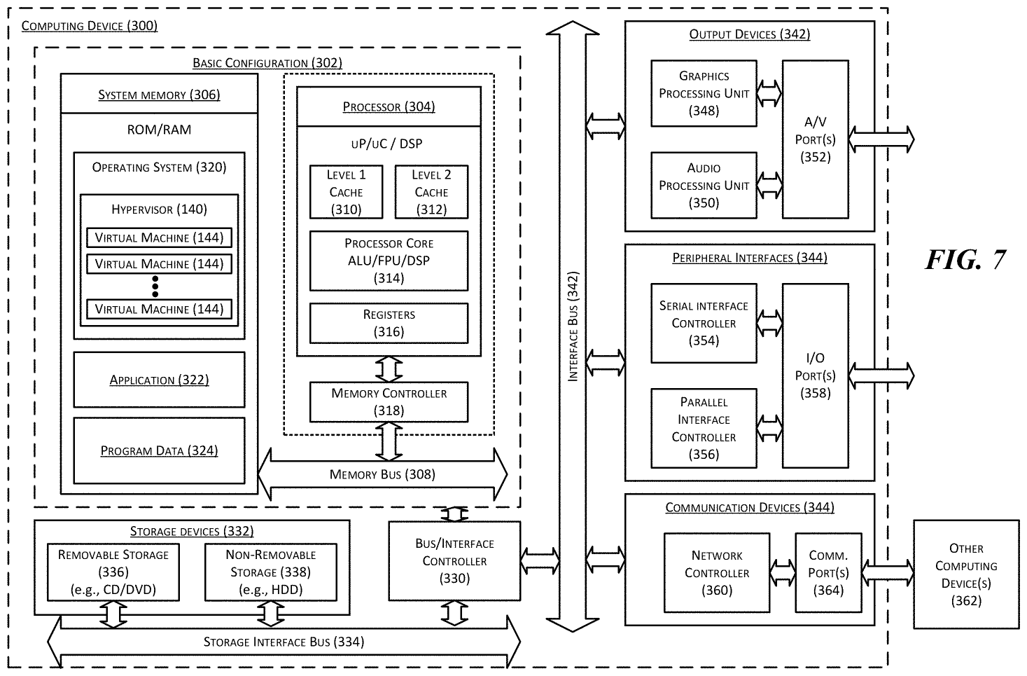

The processor 132 can include a microprocessor, caches, and/or other suitable logic devices. The memory 134 can include volatile and/or nonvolatile media (e.g., ROM; RAM, magnetic disk storage media; optical storage media; flash memory devices, and/or other suitable storage media) and/or other types of computer-readable storage media configured to store data received from, as well as instructions for, the processor 132 (e.g., instructions for performing the methods discussed below with reference to FIGS. 7A and 7B). Though only one processor 132 and one memory 134 are shown in the individual hosts 106 for illustration in FIG. 2, in other embodiments, the individual hosts 106 can include two, six, eight, or any other suitable number of processors 132 and/or memories 134.

The first and second hosts 106a and 106b can individually contain instructions in the memory 134 executable by the processors 132 to cause the individual processors 132 to provide a hypervisor 140 (identified individually as first and second hypervisors 140a and 140b) and a virtual switch 141 (identified individually as first and second virtual switches 141a and 141b). Even though the hypervisor 140 and the virtual switch 141 are shown as separate components, in other embodiments, the virtual switch 141 can be a part of the hypervisor 140 (e.g., operating on top of an extensible switch of the hypervisors 140), an operating system (not shown) executing on the hosts 106, or a firmware component of the hosts 106.

The hypervisors 140 can be configured to generate, monitor, terminate, and/or otherwise manage one or more virtual machines 144 organized into tenant sites 142. For example, as shown in FIG. 2, the first host 106a can provide a first hypervisor 140a that manages first and second tenant sites 142a and 142b, respectively. The second host 106b can provide a second hypervisor 140b that manages first and second tenant sites 142a′ and 142b′, respectively. The hypervisors 140 are individually shown in FIG. 2 as a software component. However, in other embodiments, the hypervisors 140 can be firmware and/or hardware components. The tenant sites 142 can each include multiple virtual machines 144 for a particular tenant (not shown). For example, the first host 106a and the second host 106b can both host the tenant site 142a and 142a′ for a first tenant 101a (FIG. 1). The first host 106a and the second host 106b can both host the tenant site 142b and 142b′ for a second tenant 101b (FIG. 1). Each virtual machine 144 can be executing a corresponding operating system, middleware, and/or applications.

Also shown in FIG. 2, the distributed computing system 100 can include an overlay network 108′ having one or more virtual networks 146 that interconnect the tenant sites 142a and 142b across multiple hosts 106. For example, a first virtual network 142a interconnects the first tenant sites 142a and 142a′ at the first host 106a and the second host 106b. A second virtual network 146b interconnects the second tenant sites 142b and 142b′ at the first host 106a and the second host 106b. Even though a single virtual network 146 is shown as corresponding to one tenant site 142, in other embodiments, multiple virtual networks 146 (not shown) may be configured to correspond to a single tenant site 146.

The virtual machines 144 can be configured to execute one or more applications 147 to provide suitable cloud or other suitable types of computing services to the users 101 (FIG. 1). The virtual machines 144 on the virtual networks 146 can also communicate with one another via the underlay network 108 (FIG. 1) even though the virtual machines 144 are located on different hosts 106. Communications of each of the virtual networks 146 can be isolated from other virtual networks 146. In certain embodiments, communications can be allowed to cross from one virtual network 146 to another through a security gateway or otherwise in a controlled fashion. A virtual network address can correspond to one of the virtual machines 144 in a particular virtual network 146. Thus, different virtual networks 146 can use one or more virtual network addresses that are the same. Example virtual network addresses can include IP addresses, MAC addresses, and/or other suitable addresses. To facilitate communications among the virtual machines 144, the virtual switches 141 can be configured to switch or filter packets 114 directed to different virtual machines 144 via the network interface card 136 and facilitated by the packet processor 138.

As shown in FIG. 2, to facilitate communications with one another or with external devices, the individual hosts 106 can also include a network interface controller (“NIC”) 136 for interfacing with a computer network (e.g., the underlay network 108 of FIG. 1). A NIC 136 can include a network adapter, a LAN adapter, a physical network interface, or other suitable hardware circuitry and/or firmware to enable communications between hosts 106 by transmitting/receiving data (e.g., as packets) via a network medium (e.g., fiber optic) according to Ethernet, Fibre Channel, Wi-Fi, or other suitable physical and/or data link layer standards. During operation, the NIC 136 can facilitate communications to/from suitable software components executing on the hosts 106. Example software components can include the virtual switches 141, the virtual machines 144, applications 147 executing on the virtual machines 144, the hypervisors 140, or other suitable types of components.

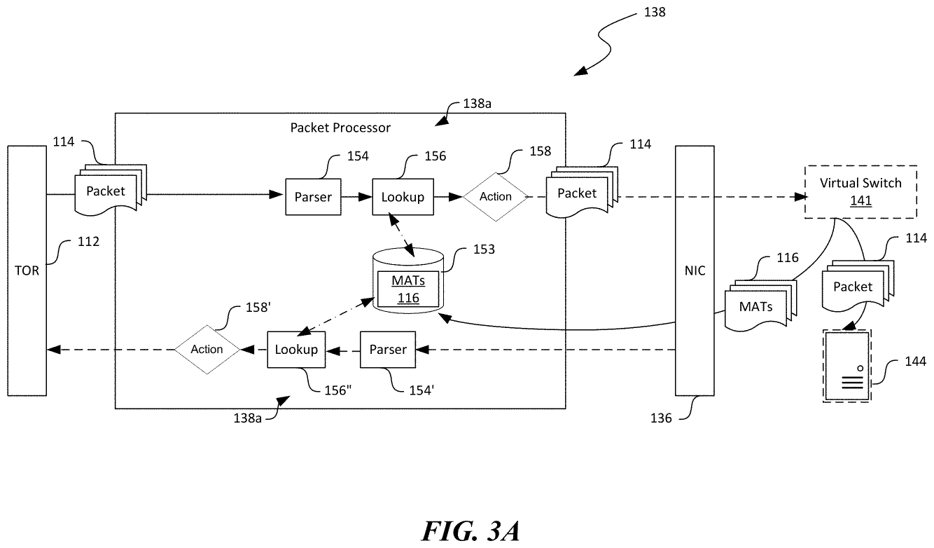

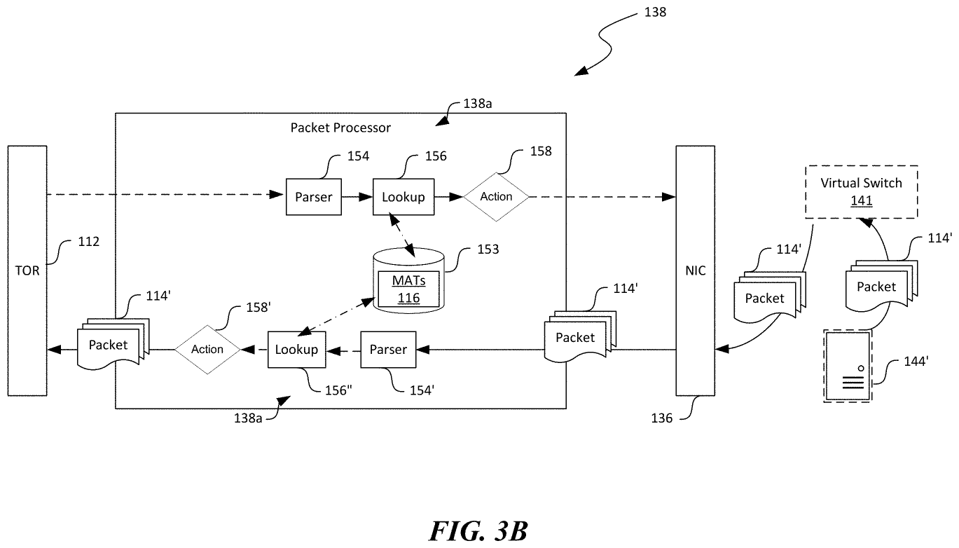

In certain implementations, a packet processor 138 can be interconnected and/or integrated with the NIC 136 to facilitate network processing operations for enforcing communications security, performing network virtualization, translating network addresses, maintaining a communication flow state, or performing other suitable functions. In certain implementations, the packet processor 138 can include a Field-Programmable Gate Array (“FPGA”) integrated with the NIC 136. An FPGA can include an array of logic circuits and a hierarchy of reconfigurable interconnects that allow the logic circuits to be “wired together” like logic gates by a user after manufacturing. As such, a user can configure logic blocks in FPGAs to perform complex combinational functions, or merely simple logic operations to synthetize equivalent functionality executable in hardware at much faster speeds than in software. In the illustrated embodiment, the packet processor 138 has one interface communicatively coupled to the NIC 136 and another coupled to a network switch (e.g., a Top-of-Rack or “TOR” switch) at the other. In other embodiments, the packet processor 138 can also include an Application Specific Integrated Circuit (“ASIC”), a microprocessor, or other suitable hardware circuitry. In any of the foregoing embodiments, the packet processor 138 can be programmed by the processor 132 (or suitable software components associated therewith) to route packets based on multi-level MATs, as described in more detail below with reference to FIGS. 3A and 3B.

In operation, the processor 132 and/or a user 101 (FIG. 1) can configure logic circuits in the packet processor 138 to perform complex combinational functions or simple logic operations to synthetize equivalent functionality executable in hardware at much faster speeds than in software. For example, the packet processor 138 can be configured to process inbound/outbound packets 114 and 114′ for individual flows according to configured policies or rules contained in a flow table such as a MAT. The flow table can contain data representing network actions corresponding to each flow for enabling private virtual networks with customer supplied address spaces, scalable load balancers, security groups and Access Control Lists (“ACLs”), virtual routing tables, bandwidth metering, Quality of Service (“QoS”), etc.

As such, once the packet processor 138 identifies an inbound/outbound packet as belonging to a flow, the packet processor 138 can apply one or more corresponding network actions in the flow table before forwarding the processed packet to the NIC 136 or TOR 112. For example, as shown in FIG. 2, the application 147, the virtual machine 144, and/or other suitable software components on the first host 106a can generate an outbound packet 114 destined to, for instance, another application 147 at the second host 106b. The NIC 136 at the first host 106a can forward the generated packet 114 to the packet processor 138 for processing according to certain policies in a flow table. Once processed, the packet processor 138 can forward the outbound packet 114 to the first TOR 112a, which in turn forwards the packet to the second TOR 112b via the overlay/underlay network 108 and 108′.

The second TOR 112b can then forward the packet 114 to the packet processor 138 at the second host 106b to be processed according to other policies in another flow table at the second hosts 106b. If the packet processor 138 cannot identify a packet as belonging to any flow, the packet processor 138 can forward the packet to the processor 132 via the NIC 136 for exception processing. In another example, when the first TOR 112a receives an inbound packet 114′, for instance, from the second host 106b via the second TOR 112b, the first TOR 112a can forward the packet 114′ to the packet processor 138 to be processed according to a policy associated with a flow of the packet 114′. The packet processor 138 can then forward the processed packet 114′ to the NIC 136 to be forwarded to, for instance, the application 147 or the virtual machine 144.

In certain implementations, the packet processor 138 is configured to process packets 114 and 114′ according to one MAT based on 5-tuples of the packets 114 and 114′. However, reliance on a MAT based on 5-tuples may cause communications interruptions due to a finite size of the MAT limited by resources available at the packet processor 138, the main processor 132, the memory 134, and/or the network interface card 136. During operation, a certain amount of resources in the first or second host 106a and 106b is consumed to manage and control operations of a flow in the MAT. As such, the number of flows in the MAT has a ceiling limited by the available resources at the first or second host 106a or 106b. Thus, as the number of flows exceeds the ceiling of the MAT, further requests for establishing additional network connections may be rejected, or one or more existing network connections may be dropped. As a result, network traffic in the overlay/underlay network 108′ and 108 may be interrupted to prevent timely delivery of computing services to users 101 and negatively impact user experience.

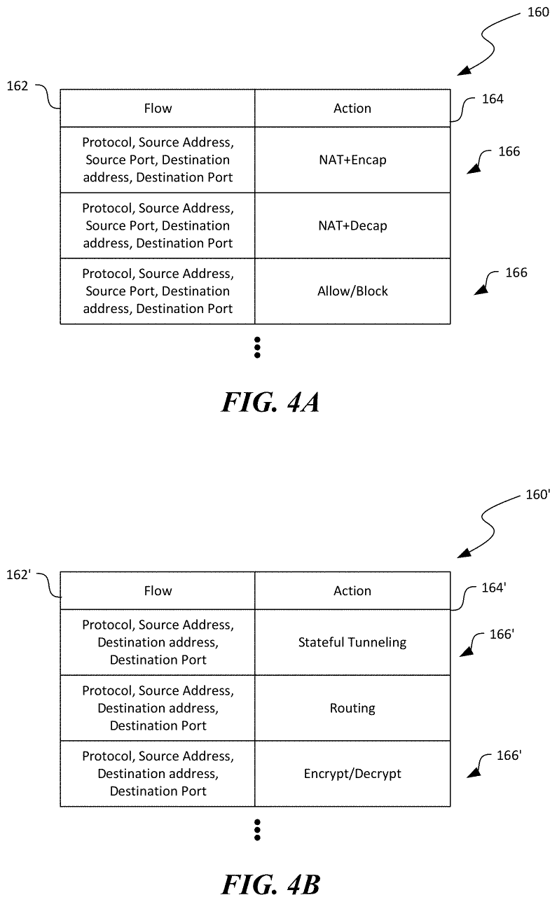

Several embodiments of the disclosed technology can address at least some aspects of the foregoing limitations by implementing multi-level MATs inside the packet processor 138, at the virtual switch 141, or at other suitable network nodes in the distributed computing system 100. Inventors have recognized that processing packets of certain network connections or flows may not require all 5-tuples. For example, an Express Route (“ER”) gateway can serve as a next hop for secured network traffic from an on-premises network (e.g., a private network of an organization) to a virtual network in a datacenter. When processing packets of the secured network traffic, the ER gateway can typically omit source address or source port during flow matching because packets with all values of source address or source port may be processed similarly. As such, the MAT can be configured to include an entry based on 4-tuples (e.g., protocol, source address, destination address, destination port) that corresponds to packets from multiple (e.g., 64,000) source addresses or source ports. Thus, the number of entries in a MAT using 4-tuples can be significantly reduced from that using 5-tuples, as described in more detail below with reference to FIGS. 3A-4B.

FIGS. 3A and 3B are schematic diagrams illustrating a hardware packet processor 138 implemented at a host 106 in a distributed computing system 100 during certain operations in accordance with embodiments of the disclosed technology. In FIGS. 3A and 3B, solid lines represent used network traffic paths while dashed lines represent unused network traffic paths.

As shown in FIG. 3A, in certain implementations, the packet processor 138 can include an inbound processing path 138a and an outbound processing path 138b in opposite processing directions. As shown in FIG. 3A, the inbound processing path 138a can include a set of processing circuits having a parser 152, a lookup circuit 156, and an action circuit 158 interconnected with one another in sequence. The outbound processing path 138b can include another set of processing circuits having a parser 152′, a lookup circuit 156′, and an action circuit 158′ interconnected with one another in sequence and in the opposite processing direction. In other embodiments, both the inbound and outbound processing paths 138a and 138b can also include buffers, multiplexers, or other suitable circuit components.

As shown in FIG. 3A, the packet processor 138 can also include a memory 153 containing multiple MATs 116 each having one or more policies or rules 116. The rules 116 can be configured by, for example, the virtual switch 141 or other suitable software components provided by the processor 132 (FIG. 2) to provide certain actions when corresponding conditions are met. In certain implementations, a first MAT 116 can include entries based on 5-tuples of packets while a second MAT 116 can include entries based on 4-tuples of the packets, as described in more detail below with reference to FIGS. 4A and 4B. In further implementations, one or more of the multiple MATs 116 can also include entries based on 3-tuples, 2-tuples, or 1-tuple. Even though the MATs 116 are shown being contained in the memory 153 in the packet processor 138 in FIG. 3A, in other embodiments, the flow table may be contained in a memory (not shown) outside of the packet processor 138, in the memory 134 (FIG. 2), or in other suitable storage locations.

FIG. 3A shows an operation of the packet processor 138 when receiving an inbound packet 114. As shown in FIG. 3A, the TOR 112 can forward the packet 114 to the packet processor 138 at the inbound parser 154. The inbound parser 154 can parse at least a portion of the header of the packet 114 to identify, for example, values of 5-tuples of the packet 114 and forward the parsed header to the lookup circuit 156 in the inbound processing path 138a. The lookup circuit 156 can then attempt to match the packet 114 to a flow based on the parsed header and identify an action for the packet 114 as contained in the MATs 116.

In accordance with certain embodiments of the disclosed technology, the lookup circuit 156 can be configured to initially perform a lookup in a first MAT 116 using a hash value of all 5-tuples of the packet 114. In response to locating an entry in the first MAT 116 that matches the hash value of all 5-tuples, the lookup circuit 156 can identify the corresponding flow and an action to be performed on the packet 114. In response to a failure to locate an entry in the first MAT 116 based on 5-tuples, the lookup circuit 156 can be configured to apply the hash function on values of 4-tuples to derive another hash value of 4-tuples. The lookup circuit 156 can then perform a lookup in a second MAT 116′ (shown in FIG. 4B) using the hash value of 4-tuples to locate an entry that corresponds to a flow and a corresponding action to be performed on the packet 114. In certain implementations, the lookup circuit 156 can be configured to recursively perform lookups in additional MATs using 3-tuples, 2-tuples, or 1-tuple until a matching entry is found or indicate that none of the MATs 116 include an entry that matches the header values of the packet 114.

When lookup circuitry 156 cannot match the packet 114 to any existing flow in the MATs, the action circuit 158 can forward the received packet 114 to a software component (e.g., the virtual switch 141) provided by the processor 132 for further processing. As shown in FIG. 3A, the virtual switch 141 (or other suitable software components) can then generates data representing a flow to which the packet 114 belongs and one or more rules 116 for the flow. The virtual switch 141 can then transmit the created rule(s) 116 to the packet processor 138 to be stored in the memory 153. In the illustrated embodiment, the virtual switch 141 also forwards the received packet 114 to a virtual machine 144. In other embodiments, the virtual switch 141 can forward the packet 114 back to the packet processor 138 to be processed by the created new rules 116 or perform other suitable operations on the packet 114.

As shown in FIG. 3B, upon receiving an outbound packet 114′ from, for instance, a first virtual machine 144′ via the NIC 136, the outbound parser 154′ can parse at least a portion of the header of the packet 114′ and forward the parsed header to the lookup circuit 156′ in the outbound processing path 138b. The lookup circuit 156′ can then match the packet 114′ to an entry in one of the MATs 116 based on the parsed header and identify an action for the packet 114′ as contained in one of the MATs 116 similarly as described above with reference to FIG. 3A. In the illustrated example, the identified action can indicate that the packet 114′ is to be forwarded to the TOR 112. The action circuit 158′ can then perform the identified action by, for example, forwarding the packet 114′ to the TOR 112 directly after optionally performing packet transposition and/or other suitable packet modifications.

The foregoing implementation can be useful significantly reduce sizes of MATs 116 in the packet processor 138, the virtual switches 141, NICs 132, or other network nodes in the distributed computing system 100. By using values of 4-tuples instead of values of 5-tuples, flows from multiple source port (or source address) can be aggregated into a single network connection or flow. Thus, a risk of exceeding a ceiling for the first or second MAT can be reduced to accommodate additional numbers of network connections or flows. As a result, dropped connections or connection refusals can be reduced to improve user experience of various computing services provided in the distributed computing system 100.

FIGS. 4A and 4B are schematic diagrams illustrating MATs 116 indexed to different packet parameters in accordance with embodiments of the disclosed technology. As shown in FIG. 4A, a first MAT 116 can be organized as a table with a first column 162 representing flow parameters and a second column 164 representing corresponding network actions 164. Each row 166 of the table represents an entry in the first MAT 116. For instance, in the illustrated example, the flow parameters are based on 5-tuples of packets, i.e., protocol, source address, source port, destination address, and destination port. The corresponding network actions can include network name translation (“NAT”), encapsulation, decapsulation, and allow/block packets.

As shown in FIG. 4B, a second MAT 160′ can include a first column 162′ that contain flow parameters based on 4-tuples of packets, i.e., protocol, source address, destination address, and destination port, instead of 5-tuples. The corresponding network actions in the second column 164′ can include stateful tunneling, routing, and encryption/decryption. Each row 166′ of the table represents an entry in the second MAT 116. In other examples, the first column 162′ of the second MAT 160′ can also include flow parameters that are different than those shown in FIG. 4B. For instance, the first column 162′ can include flow parameters of 4-tuples having source port instead of source address. The various flow parameters in the first and second MATs 160 and 160′ can be used to perform flow action matching using header values extracted from packets, such as those described below with reference to FIGS. 5A and 5B.

FIGS. 5A and 5B illustrate an example data schema 180 suitable for a packet header in accordance with embodiments of the disclosed technology. As shown in FIG. 5A, the data schema 180 can include a MAC field 181, an IP field 182, a TCP field 183, a TLS field 184, an HTTP field 185, and a data field 186. The MAC field 181, the IP field 182, and the TCP field 183 can be configured to contain a MAC address, an IP address, and a port number of the NIC 136 (FIG. 2) and/or the host 106 (FIG. 2), respectively. The TLS field 185 can be configured to contain a value indicating a type of data contained in the packet. Example values for the TLS field 184 can include APPLICATION_DATA, ALERT, or HANDSHAKE. The HTTP field 185 can be configured to contain various parameters according to the HTTP protocol. For example, the parameters can include a content length of the data in the data field 186, cache control, etc. Example header fields of the IP field 182 and TCP field 183 are described in more detail with reference to FIG. 5B. Even though the example data schema 180 includes the HTTP field 185, in other embodiments, the data schema 180 can include Secure Shell, Secure Copy, Secure FTP, or other suitable header fields. In further embodiments, the data schema 180 can include one or more levels of encapsulation headers (not shown) each having an IP field 182, a TCP field 183, or other suitable data fields. Various network processing techniques using multi-level MATs can be applied to one level of header or multiple levels of headers.

FIG. 5B is a schematic diagram illustrating example header fields suitable for the IP field 182 and TCP field 183 in FIG. 5A in accordance with embodiments of the disclosed technology. As shown in FIG. 5B, the header fields in the IP field 182 can include header fields of IP version 191 (e.g., “IPv4”), source address 192 (e.g., “10.0.01”), destination address 194 (e.g., 192, 168.1.1”), and a time to live 196 (e.g., “240” seconds). The TCP field 183 can include source port 193 (e.g., 20) and destination port 195 (e.g., “90”). Though particular header fields are shown in FIG. 5B as examples, in other embodiments, the IP field 182, the TCP field 183, or other suitable fields can also include fields configured to contain content language, content location, content range, and/or other suitable parameters.

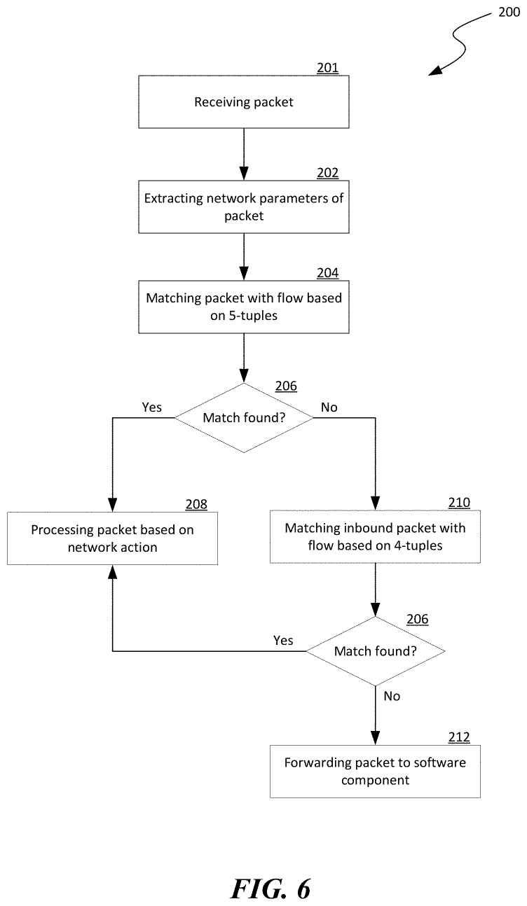

FIG. 6 is a flowchart illustrating a process 200 for network processing using multi-level MATs in accordance with embodiments of the disclosed technology. Though the process 200 is described below in light of the distributed computing system 100 of FIGS. 1-4B, in other embodiments, the process 200 can also be performed in other computing systems with similar or different components.

As shown in FIG. 6, the process 200 can include receiving a packet at stage 201. The packet can include a header with a protocol field, a source address field, a source port field, a destination address field, and a destination port field individually containing a corresponding value. In certain embodiments, the packet may be received at a packet processor 138 (FIG. 2) from a TOR 112 (FIG. 2) interconnected to a host 106 (FIG. 2) incorporating the packet processor 138. In other embodiments, the packet may be received from other suitable network nodes by, for instance, the virtual switch 141 (FIG. 2) or other suitable network nodes.

The process 200 can then include extracting network parameters of the received packet at stage 202. In certain embodiments, the extracted network parameters can include values of the protocol field, the source address field, the source port field, the destination field, and the destination port field. In other embodiments, the extracted network parameters can also include a MAC address, a TCP parameter, or other suitable network parameters. The process 200 can then include matching the packet with a flow in a MAT based on extracted values of 5-tuples of the packet at stage 204. In certain implementations, the extracted values of 5-tuples can be hashed to derive a hash value, which can then be used as an index or key to locate an entry in the MAT.

The process 200 can then include a decision stage 206 to determine whether the MAT has an entry that matches the network parameters of the packet based on 5-tuples. In response to determining that the MAT has an entry that matches the network parameters of the packet based on 5-tuples, the process 200 can include identifying a network action in the entry that matches the network parameters of the packet and processing the packet based on the identified network action at stage 208. Otherwise, the process 200 proceeds to matching the packet with a flow in another MAT based on extracted values of 4-tuples of the packet at stage 210.

The process 200 can then include another decision stage 206 to determine whether the other MAT includes an entry that matches the network parameters of the packet based on extracted values of 4-tuples. In response to determining that the other MAT has an entry that matches the network parameters of the packet based on 4-tuples, the process 200 can revert to identifying a network action in the entry that matches the network parameters of the packet and processing the packet based on the identified network action at stage 208. Otherwise, the process 200 can include forwarding the packet to a software component (e.g., a virtual switch) for further processing at stage 212.

FIG. 7 is a computing device 300 suitable for certain components of the distributed computing system 100 in FIG. 1. For example, the computing device 300 can be suitable for the hosts 106, the client devices 102, or the platform controller 125 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. As shown in FIG. 7, the operating system 320 can include a hypervisor 140 for managing one or more virtual machines 144. This described basic configuration 302 is illustrated in FIG. 8 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable, and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information, and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more NV ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for processing network traffic in a distributed computing system having multiple hosts interconnected by a computer network, the individual hosts having a processor, a network interface card (“NIC”), and a hardware packet processor operatively coupled to one another, the method comprising:
receiving, from the computing network, a packet at the packet processor of a host, the packet having a header with a protocol field, a source address field, a source port field, a destination address field, and a destination port field individually containing a corresponding value; and
in response to receiving the packet, at the hardware packet processor,
extract, from the header of the packet, the values of the protocol field, the source address field, the source port field, the destination field, and the destination port field;
determining whether a first match action table (“MAT”) accessible to the hardware processor contains an entry indexed to the extracted values of the protocol field, the source address field, the source port field, the destination field, and the destination port field, the hardware packet processor having access to a second MAT having entries indexed to a subset of the protocol field, the source address field, the source port field, the destination field, and the destination port field; and
in response to determining that the first MAT does not contain an entry indexed to the extracted values,
performing a lookup in the second MAT using a subset of the extracted values as an index to identify one of the entries in the second MAT, the one of the entries in the second MAT identifying a network action to be performed on the packet; and
processing the packet according to the network action in the identified entry in the second MAT before forwarding the processed packet to the NIC.

2. The method of claim 1, further comprising:
in response to determining that the first MAT contains an entry indexed to the extracted values,
identifying a network action corresponding to the entry in the first MAT;
processing the packet according to the network action corresponding to the entry in the first MAT; and
skipping performing the lookup in the second MAT using the subset of the extracted values.

3. The method of claim 1 wherein performing the lookup in the second MAT using the subset of the extracted values includes:
determining whether the second MAT contains the entry corresponding to the subset of the extracted values of the protocol field, the source address field, the source port field, the destination field, and the destination port field of the packet;
in response to determining that the second MAT does not contain the entry corresponding to the subset of the extracted values of the protocol field, the source address field, the source port field, the destination field, and the destination port field of the packet, performing another lookup in a third MAT using another subset of the extracted values of the protocol field, the source address field, the source port field, the destination field, and the destination port field to identify a further entry in the third MAT, the another subset being smaller than the subset of the extracted values of the protocol field, the source address field, the source port field, the destination field, and the destination port field.

4. The method of claim 1 wherein:
the packet is a first packet;
the extracted values are extracted first values; and
the method further includes, upon receiving a second packet at the network node,
extracting second values of the protocol field, the source address field, the source port field, the destination field, and the destination port field from the second packet; and
using a subset of the extracted second values to identify a further entry in the second MAT, the further entry in the second MAT being the same entry corresponding to the entry identified using the subset of the extracted first values.

5. A method for processing network traffic in a distributed computing system having multiple hosts interconnected by multiple network nodes in a computer network, the method comprising:
receiving, a packet at a network node of the computer network, the packet having a header with a protocol field, a source address field, a source port field, a destination address field, and a destination port field individually containing a corresponding value; and
in response to receiving the packet,
extracting, from the header of the packet, the values of the protocol field, the source address field, the source port field, the destination field, and the destination port field;
determining whether a first match action table (“MAT”) contains an entry indexed to the extracted values of the protocol field, the source address field, the source port field, the destination field, and the destination port field; and
in response to determining that the first MAT does not contain an entry indexed to the extracted values, using a subset of the extracted values of the protocol field, the source address field, the source port field, the destination field, and the destination port field to identify another entry in a second MAT, the another entry in the second MAT identifying a network action to be performed on the packet.

6. The method of claim 5, further comprising:
in response to determining that the first MAT contains an entry indexed to the extracted values,
identifying a network action corresponding to the entry in the first MAT; and
processing the packet according to the network action corresponding to the entry in the first MAT.

7. The method of claim 5 wherein using the subset of the extracted values of the protocol field, the source address field, the source port field, the destination field, and the destination port field to identify another entry in a second MAT includes using the extracted values of the protocol field, the source address field, the destination field, and the destination port field to identify the another entry in the second MAT.

8. The method of claim 5 wherein using the subset of the extracted values of the protocol field, the source address field, the source port field, the destination field, and the destination port field to identify another entry in a second MAT includes using the extracted values of the protocol field, the source port field, the destination field, and the destination port field to identify the another entry in the second MAT.

9. The method of claim 5 wherein using the subset of the extracted values of the protocol field, the source address field, the source port field, the destination field, and the destination port field to identify another entry in the second MAT includes:
determining whether the second MAT contains the another entry corresponding to the subset of the extracted values of the protocol field, the source address field, the source port field, the destination field, and the destination port field of the packet;
in response to determining that the second MAT does not contain the another entry corresponding to the subset of the extracted values of the protocol field, the source address field, the source port field, the destination field, and the destination port field of the packet, using another subset of the extracted values of the protocol field, the source address field, the source port field, the destination field, and the destination port field to identify a further entry in a third MAT, the another subset being smaller than the subset of the extracted values of the protocol field, the source address field, the source port field, the destination field, and the destination port field.

10. The method of claim 5 wherein:
the packet is a first packet;
the extracted values are extracted first values; and
the method further includes, upon receiving a second packet at the network node,
extracting second values of the protocol field, the source address field, the source port field, the destination field, and the destination port field from the second packet; and
using a subset of the extracted second values to identify a further entry in the second MAT, the further entry in the second MAT being the same entry corresponding to the another entry identified using the subset of the extracted first values.

11. The method of claim 5 wherein:
the packet is a first packet;
the extracted values are extracted first values; and
the method further includes, upon receiving a second packet at the network node,
extracting second values of the protocol field, the source address field, the source port field, the destination field, and the destination port field from the second packet, the extracted second values are the same as the first extracted values except in the source port field; and
using the extracted second values in the protocol field, the source address field, the destination field, and the destination port field to identify a further entry in the second MAT, the further entry in the second MAT being the same as the another entry identified using the subset of the extracted first values.

12. The method of claim 5 wherein:
the packet is a first packet;
the extracted values are extracted first values; and
the method further includes, upon receiving a second packet at the network node,
extracting second values of the protocol field, the source address field, the source port field, the destination field, and the destination port field from the second packet, the extracted second values are the same as the first extracted values except in the source address field; and
using the extracted second values in the protocol field, the source port field, the destination field, and the destination port field to identify a further entry in the second MAT, the further entry in the second MAT being the same as the another entry identified using the subset of the extracted first values.

13. The method of claim 5 wherein:
the packet is a first packet;
the extracted values are extracted first values; and
the method further includes, upon receiving a second packet at the network node,
extracting second values of the protocol field, the source address field, the source port field, the destination field, and the destination port field from the second packet, the extracted second values are the same as the first extracted values except in the source address field; and
using the extracted second values in the protocol field, the source port field, the destination field, and the destination port field to identify a further entry in the second MAT, the further entry in the second MAT being the same as the another entry identified using the subset of the extracted first values.

14. A computing device in a distributed computing system having multiple computing devices interconnected by multiple network nodes in a computer network, the computing device comprising:
a processor;
a network interface card; and
a hardware packet processor interconnected to one another, wherein the hardware packet processor is configured to, upon receiving, a packet from the computer network,
extract, from a header of the packet values of a protocol field, a source address field, a source port field, a destination address field, and a destination port field of the packet;
determine whether a first match action table (“MAT”) contains an entry indexed to the extracted values of the protocol field, the source address field, the source port field, the destination field, and the destination port field; and
in response to determining that the first MAT does not contain an entry indexed to the extracted values,
identify another entry in a second MAT using a subset of the extracted values of the protocol field, the source address field, the source port field, the destination field, and the destination port field as an index, the another entry in the second MAT identifying a network action to be performed on the packet; and
process the packet according to the network action in the identified another entry.

15. The computing device of claim 14 wherein the hardware packet processor is further configured to:
in response to determining that the first MAT contains an entry indexed to the extracted values,
identify a network action corresponding to the entry in the first MAT;
process the packet according to the network action corresponding to the entry in the first MAT; and
skip identifying another entry in the second MAT using the subset of the extracted values.

16. The computing device of claim 14 wherein using the subset of the extracted values of the protocol field, the source address field, the source port field, the destination field, and the destination port field includes using the extracted values of the protocol field, the source address field, the destination field, and the destination port field to identify the another entry in the second MAT.

17. The computing device of claim 14 wherein using the subset of the extracted values of the protocol field, the source address field, the source port field, the destination field, and the destination port field includes using the extracted values of the protocol field, the source port field, the destination field, and the destination port field to identify the another entry in the second MAT.

18. The computing device of claim 14 wherein using the subset of the extracted values of the protocol field, the source address field, the source port field, the destination field, and the destination port field includes:
determining whether the second MAT contains the another entry corresponding to the subset of the extracted values;
in response to determining that the second MAT does not contain the another entry corresponding to the subset of the extracted values, using another subset of the extracted values of the protocol field, the source address field, the source port field, the destination field, and the destination port field to identify a further entry in a third MAT, the another subset being smaller than the subset of the extracted values of the protocol field, the source address field, the source port field, the destination field, and the destination port field.

19. The computing device of claim 14 wherein:
the packet is a first packet;
the extracted values are extracted first values; and
the hardware packet processor is further configured to, upon receiving a second packet at the network node,
extract second values of the protocol field, the source address field, the source port field, the destination field, and the destination port field from the second packet; and
use a subset of the extracted second values to identify a further entry in the second MAT, the further entry in the second MAT being the same entry corresponding to the another entry identified using the subset of the extracted first values.

20. The computing device of claim 14 wherein:
the packet is a first packet;
the extracted values are extracted first values; and
the hardware packet processor is further configured to, upon receiving a second packet at the network node,
extract second values of the protocol field, the source address field, the source port field, the destination field, and the destination port field from the second packet, the extracted second values are the same as the first extracted values except in the source port field; and
use the extracted second values in the protocol field, the source address field, the destination field, and the destination port field to identify a further entry in the second MAT, the further entry in the second MAT being the same as the another entry identified using the subset of the extracted first values.
